(19) United States
(12) Patent Application Publication
(10) Pub. No.: US 2022/0066474 A1
(43) Pub. Date: Mar. 3, 2022

(54) METHOD FOR SIGNAL SELECTION AND SIGNAL SELECTION APPARATUS

(71) Applicant: Volocopter GmbH, Bruchsal (DE)

(72) Inventors: Markus ORTLIEB, Karlsruhe (DE); Florian-Michael ADOLF, Frankfurt Am Main (DE)

(73) Assignee: Volocopter GmbH, Bruchsal (DE)

(21) Appl. No.: 17/464,855

(22) Filed: Sep. 2, 2021

(30) Foreign Application Priority Data
Sep. 3, 2020 (DE) 102020123062.1

(51) Int. Cl. G05D 1/10; B64C 29/00; B64C 39/02; G05D 1/00

(52) U.S. Cl. CPC G05D 1/102; B64C 29/00; B64C 2201/146; G05D 1/0016; B64C 39/024

(57) ABSTRACT

A method for signal selection for a flight system having an aircraft, and having a signal selection apparatus that receives first and second control signals, wherein at least the first or the second control signal is dependent on a remote control input from a pilot and/or an autopilot, and uses an analysis logic circuit to ascertain a piece of first reliability information for the first control signal and a piece of second reliability information for the second control signal. In step A, a system state of the aircraft is ascertained based on at least a piece of state information and/or a piece of mission information of the aircraft; in step B, an automated, formal decision logic circuit is used to take the first and second reliability information and the system state and a control hierarchy as a basis for prioritizing the first or second control signal; in step C, either the first or second control signal is output in the form of a prioritized control signal.

### INCORPORATION BY REFERENCE

The following documents are incorporated herein by reference as if fully set forth: German Patent Application No. 10 2020 123 062.1, filed Sep. 3, 2020.

### TECHNICAL FIELD

The invention relates to the preamble of claim 1. The invention also relates to a signal selection apparatus, an aircraft, a ground station, and a flight system.

### BACKGROUND

During normal flight, there are frequently multiple control signals available for controlling an aircraft. In particular in a distributed system, a pilot in command (PiC) needs to be determined.

The pilot in command can appear both in the form of hardware and software implementations and in the form of a human pilot aboard or outside the aircraft, for example in the form of a pilot and an autopilot. If there are multiple, in particular conflicting, control signals from different sources, it is therefore necessary to select one of these control signals.

The aviation authority EASA uses the EASA Certified Unmanned Aircraft Category to define unmanned flight (type 2) and manned flight (type 3), which allow safety-critical missions over cities for the purpose of transporting people and freight. In particular such missions require handover procedures between pilots in command to be carried out safely, correctly and on time. Besides the purely unmanned mode (type 2), a hybrid mode with human pilots aboard (permeability type 2 and type 3 operations) is also desirable, which uses individual automation functions as an assistance system or is available as a safety pilot at early stages of automated flight operation.

In order to carry out the handover procedures safely, correctly and on time, signal selection methods and apparatuses are required that allow selection of the correct control signal, from the point of view of safety, from multiple control signals.

The prior art discloses signal selection methods and signal selection apparatuses that can be used to select a prioritized control signal of this kind from at least a first and a second control signal.

Signal selection apparatuses in the form of electronic selection circuits (also: multiplexers) are known in this case. These have a plurality of inputs into which an applicable number of control signals can be input. An external selection signal can be used to connect at least one of the incoming control signals to an output of the selection circuit and thereby to output said control signal(s).

The decision about which of the control signals is connected to the output of the multiplexer can be made on the basis of the signal properties of the control signals. In this regard, US 2019\031330 A1 teaches the practice of analyzing control signals in respect of their reliability. This involves e.g. ascertaining whether a control signal is based on reliable sensor information or brings about a safe flight maneuver in which the aircraft to be controlled moves within a stipulated safety corridor.

Reliability information for a control signal is ascertained by using statistical methods and methods of machine learning. If one control signal is attributed low reliability on the basis of the ascertained parameters then a different control signal is selected as an overwrite signal for controlling the aircraft.

A disadvantage of known methods and apparatuses can be seen in that the signal selection is made only on the basis of reliability information. The reliability information is therefore the only decision criterion, on the basis of which a signal selection is made. This is disadvantageous in particular because a negative characteristic of a control signal, e.g. high variance, can be compensated for by a positive characteristic of the control signal, e.g. high data density. This means that an unsuitable control signal may be selected, which decreases safety during flight.

Another disadvantage of the previously known solutions is that only internal control signals are processed. External control signals, for example from a tower or a ground station, are ignored.

### SUMMARY

The invention is therefore based on the object of eliminating the cited disadvantages and ensuring greater safety for the operation of aircraft in flight systems.

The object is achieved by a method for signal selection having one or more of the features disclosed herein. Advantageous configurations of the method can be found below and in the claims. Furthermore, the object is achieved by a signal selection apparatus having one or more of the features disclosed herein. Advantageous configurations of the apparatus can be found below and in the claims. The object is also achieved by an aircraft having one or more of the features disclosed herein. Advantageous configurations of the aircraft can be found below and in the claims. Similarly, the object is achieved by a ground station and a flight system having one or more of the features described herein. To avoid repetition, the claims are hereby explicitly incorporated into the description by way of reference.

In the method for signal selection according to the invention, a signal selection apparatus receives at least a first control signal and a second control signal. As is known per se, an analysis logic circuit is used to ascertain a piece of first reliability information for the first control signal and a piece of second reliability information for the second control signal.

A crucial aspect for the method according to the invention is that at least the first and/or the second control signal is dependent on a remote control input from a pilot and/or an autopilot and that, in a method step A, a system state of the aircraft is ascertained on the basis of at least a piece of state information and/or a piece of mission information of the aircraft. In a method step B, an automated, formal decision logic circuit is used to take the first and the second reliability information and the system state and a control hierarchy as a basis for prioritizing the first or the second control signal. In a method step C, the prioritized control signal is output.

The labels first control signal and second control signal, or first reliability information and second reliability information, are nonlimiting as far as the number or order of the signals and/or reliability information is concerned. Rather, the number and order of signals arriving at essentially the same time are arbitrary. The only critical factor is that each signal is assigned reliability information.

The reliability information preferably contains information about the statistical and/or signal-theory characteristics of the respective analyzed control signal. By way of example, the reliability information contains parameters or parameter sets describing the signal quality, data corruption, frequency and/or packet loss within a control signal. Provided that a control signal is conveyed to the signal selection apparatus by a protocol-based data link, the protocol used can be used to check the control signal e.g. for completeness or to ascertain the source of the control signal. This in particular allows a control signal to be identified as a remote control signal.

The invention is founded upon the applicant's insight that, besides the reliability information of the control signals, consideration of further information for the signal selection increases safety in a flight system. Input variables for the decision logic circuit, according to the invention, are the reliability information of the incoming control signals, the system state of the aircraft and the control hierarchy.

For the purposes of the invention, the system state of the aircraft can be restricted to the aircraft and the components thereof as a “system”; preferably, however, the system state covers all air and ground components involved in the operation of the aircraft.

The system state of the aircraft is independent of the control signals and therefore independent of the reliability information. This results in the advantage that safety, in particular on handover between pilots in command, is increased in comparison with the prior art.

The object according to the invention is likewise achieved by a signal selection apparatus having one or more of the features described herein.

The signal selection apparatus according to the invention for a flight system having an aircraft is designed to receive a first control signal and a second control signal. The signal selection apparatus has an implemented analysis logic circuit designed to ascertain a piece of first reliability information for the first control signal and a piece of second reliability information for the second control signal.

A crucial aspect for the signal selection apparatus according to the invention is that the signal selection apparatus is designed to receive at least the first or the second control signal from a remote control input from a pilot and/or an autopilot and to ascertain a system state of the aircraft on the basis of at least a piece of state information and/or a piece of mission information of the aircraft. Furthermore, the signal selection apparatus has an implemented decision logic circuit, executable in automated fashion, that is designed to prioritize the first or the second control signal on the basis of the first and the second reliability information and the system state and a control hierarchy, the signal selection apparatus being designed to output the prioritized control signal by means of a protocol-based data link.

The signal selection apparatus according to the invention can be designed as part of an onboard computer or a controller aboard an aircraft. Similarly, the signal selection apparatus can be designed as part of a ground station, in particular an airfield for vertical takeoff and landing aircraft (vertiport), or a navigation apparatus. Regardless of the embodiment, the signal selection apparatus according to the invention is preferably designed to perform the method for signal selection according to the invention. Therefore, the signal selection apparatus according to the invention and the method for signal selection according to the invention achieve fundamentally the same advantages.

The system state of the aircraft is determined on the basis of state information and/or mission information of the aircraft.

The state information is preferably ascertained on the basis of data such as a vertical acceleration, the airspeed or a rate of turn of the aircraft, which are able to be determined on the basis of individual determinable positions and/or sensor information of the aircraft. The state information can contain information about the airspace or for example a potential collision course.

The mission information preferably provides information about the operational states when the aircraft is on the ground (“ground”) or in flight (“mission”) with the various flight phases such as takeoff, cruising and landing.

The mission information can be ascertained on the basis of the state information, e.g. by being able to assign dynamic states characteristic of the takeoff process to a flight takeoff with sufficient probability. The state information and the mission information therefore each comprise one or more parameters that can be used to monitor the aircraft during its operation.

Single pieces or multiple pieces of state information and/or mission information can be combined and reveal the system state of the aircraft. The system state can be used to describe flight operation. This includes e.g. information about whether flight operation is running according to plan and which phase of the flight the aircraft is currently in.

Preferably, each system state has an assigned unique flight-phase-dependent control hierarchy. Preferably, each system state can be assigned a unique prioritization of the systems available for flight control, for example can be assigned a relevant pilot. The control hierarchies are e.g. stored in the form of a multidimensional database.

The system state and the reliability information are two separate variables that are input into the formal decision logic circuit in order to ascertain the prioritized control signal. Therefore, the ascertainment of the prioritized control signal is, in contrast to the prior art, not solely dependent on a single decision criterion in the form of the reliability information.

Preferably, the formal decision logic circuit is designed to evaluate the input reliability information, which means that said reliability information is used in the prioritization of a control signal. The statistical or signal-theory parameters of the reliability information are used to assess the availability of a system that is involved and the reliability of the data conveyed. The reliability information is therefore used as an input variable for the decision logic circuit that makes the selection for the pilot that is best suited at the present time. In the simplest case, this can be presented as a large transition table.

As already described, each system state preferably has an assigned unique flight-phase-dependent control hierarchy. Furthermore, it is advantageous if the control hierarchy takes account of model assumptions, simulation studies, results from experiments and/or expert knowledge and also regulatory constraints.

After the prioritized control signal has been ascertained, it is output. Preferably, the output is effected by a wireless data connection, in particular a data link, if the signal selection method is performed spatially separately from an aircraft that is to be controlled. Similarly, it is within the scope of the invention for the method for signal selection to be performed aboard an aircraft, while the control signals are input via one or more data links.

In one advantageous configuration of the method, the first and/or the second reliability information is/are ascertained in each case using probabilistic or formal methods, preferably using Bayesian filters and/or temporal logic circuits. Preferably, the incoming control signals are analyzed by means of formal or data-driven methods in respect of a multiplicity of relevant parameters, such as e.g. the signal quality, data corruption, frequency, packet loss, etc. The advantage of this analysis is that formal or probabilistic guarantees can be provided for the analysis result, which means that incorrect decisions can be ruled out completely or with sufficient probability.

In another advantageous development, the state information and/or the mission information of the aircraft is/are conveyed by a runtime monitoring system in method step A.

In one preferred embodiment of the invention, the runtime monitoring system ascertains the system state on the basis of all available information about the aircraft and the surroundings. To this end, the runtime monitoring system preferably uses suitable components such as for example sensors to capture the required data and/or receives external information. The sensors are designed to monitor flight operation of the aircraft. Preferably, the runtime monitoring system ascertains the state information and/or the mission information in a repeatable manner. In particular, multiple ascertained pieces of state information and/or mission information can easily be compared with one another between multiple times or flight states of the aircraft in order to ascertain abnormalities in the system state.

It is advantageous if the runtime monitoring system is designed independently of the generation of the control signals, which means that negative interactions between control signals and state information and/or mission information are avoided. This further increases an ascertainable system state's independence of any errors in the control signals and improves the reliability of the signal selection.

It is within the scope of the invention for the control signals and the state information to be conveyed to the signal selection apparatus via one and the same communication path. This can in particular be a protocol-based data link in the case of which the control signals and the state information and/or the mission information are clearly separable from one another on the basis of respective transmission protocols.

In another advantageous development, the control hierarchy is selected from a multiplicity of control hierarchies in a database on the basis of the system state and/or the first and the second reliability information, preferably taking account of regulatory constraints. The availability or reliability of the control functions listed in the control hierarchy can then determine which control component is ultimately chosen as pilot in command.

The control hierarchy is advantageously stored in a database.

The database is available e.g. in the form of a multidimensional matrix that can be continually adapted or extended. In particular, the database can be accessed in a decentralized manner in order to adapt or extend it. This allows the control hierarchies stored in the database to be altered, verified or rejected by the pilot during or following completion of a flight maneuver. This allows the method for signal selection to be sustainably optimized in particular in respect of the formal decision logic circuit.

In a different advantageous configuration, the method for signal selection is carried out as a spatially distributed selection method, in particular with decentralized control preselection and/or decentralized signal processing on the basis of spatially distributed subsystems.

A spatially distributed selection method provides for a spatial separation for the generation of the control signals, the ascertainment of their associated reliability information and the performance of method steps A to C. The spatial separation in the generation of the control signals can be designed in the form of spatially separate flight guidance functions, which are provided on separate hardware modules inside and outside the aircraft. These include flight guidance modules for defined flight phases, such as takeoff, avoidance or landing.

Alternatively, at least some of the flight guidance functions can be provided on a shared hardware module, the whole of which is designed as part of a ground station, however. In this instance, the whole of the signal selection apparatus is likewise on the ground, which means that only the prioritized control signal now needs to be conveyed to the aircraft. This reduces the required data bandwidth for the remote control of aircraft.

Alternatively, the flight guidance modules can be designed as part of one or more ground stations, while the signal selection apparatus is arranged aboard the aircraft. This also allows exclusively remotely controllable aircraft to be operated reliably.

In a different advantageous configuration of the invention, the method is carried out as a cascaded method, wherein the signal selection apparatus receives at least the first or the second control signal from a subordinate signal selection apparatus. Additionally or alternatively, the signal selection apparatus outputs the prioritized control signal to a superordinate signal selection apparatus.

The cascaded method can be a special form of the spatially distributed method for signal selection. In addition to the features of the spatially distributed method, the cascaded method is performed on the basis of at least two signal selection apparatuses connected in series.

In an arrangement cascaded in this manner, a first control apparatus receives a first and a second control signal, while a second control apparatus receives a third and a fourth control signal. In total, there are therefore four control signals available for controlling an aircraft. By performing the method steps according to the invention in the first and second signal selection apparatuses, it is first of all possible for two prioritized control signals to be ascertained, which are in turn each input as first or second control signal into a third, superordinate signal selection apparatus. The third signal selection apparatus ascertains a final, prioritized control signal therefrom. Advantageously, the signal selection apparatuses are of the same structural design, which means that they can easily be interchanged if required.

In a different advantageous configuration of the invention, the method comprises a method step D, in which the aircraft receives the prioritized control signal and takes the prioritized control signal as a basis for autonomously changing over between at least a first and a second operating state.

This results in the advantage that the prioritized control signal does not need to be checked by means of a further safety check in order to be able to intervene in flight operation of the aircraft. All safety-relevant criteria are taken into account in the formal decision logic circuit on the basis of the reliability signals and also the system state and the control hierarchy. This allows a hybrid mode between unmanned flight, in particular according to type 2 of the Certified Unmanned Aircraft Category of the aviation authority EASA, and manned flight, in particular according to type 3 of the Certified Unmanned Aircraft Category of the aviation authority EASA. This permits safety-critical missions to be carried out over cities for the purpose of transporting people and freight.

In another advantageous configuration, the signal selection apparatus stores at least the received first control signal and the received second control signal, the ascertained reliability information, the system state and the overwrite signal with at least a respective associated timestamp and/or a piece of event information in a flight recorder in method step C.

In contrast to known flight recorders, this involves not only the relevant flight parameters being captured during a flight but also all input parameters required for performing the method for signal selection according to the invention or one of the advantageous developments thereof. It is therefore possible to reconstruct emergency situations in respect of the signal selection after the aircraft has landed safely and therefore to substantiate and/or optimize the functional safety of the signal selection apparatus.

In one preferred embodiment of the invention, the signal selection apparatus is designed to receive a first control signal and a second control signal, wherein at least the first or the second control signal is dependent on a remote control input from a pilot and/or an autopilot.

A computing unit integrated in the signal selection apparatus is preferably designed, by means of an implemented analysis logic circuit, to ascertain a piece of first reliability information for the first control signal and to ascertain a piece of second reliability information for the second control signal. The computing unit is designed to ascertain a system state of the aircraft on the basis of at least a piece of state information and/or a piece of mission information of the aircraft and to use an implemented decision logic circuit, executable in automated fashion, to prioritize the first or the second control signal on the basis of the first and the second reliability information and the system state and a control hierarchy. The signal selection apparatus is additionally designed to output the prioritized control signal by means of a protocol-based data link.

The signal selection apparatus according to the invention can be designed as part of an onboard computer or a control device aboard an aircraft. Similarly, the signal selection apparatus can be designed as part of a ground station, in particular a vertiport, or a navigation apparatus. Regardless of its embodiment, the signal selection apparatus according to the invention is preferably designed to perform the method for signal selection according to the invention. Therefore, the signal selection apparatus according to the invention and the method for signal selection according to the invention achieve fundamentally the same advantages.

Preferably, the signal selection apparatus comprises an analog and/or a digital module for data transmission that can be used to receive control signals and to output the prioritized control signal.

This can be realized by a data link that realizes a data transmission by using a transmission protocol. By using a transmission protocol, a plurality of transmitters of control signals can be assigned to one or more suitable receivers. Furthermore, the transmission protocol can be used to communicate not only the communicated control signals but also information about the required signal structure in the form of meta information. This meta information can relate e.g. to the packet size of a signal that must be expected by a receiver. In the case of multipart data transmissions, the transmission protocol can furthermore be used to provide notification of the quantity and also the serial number of a packet. The use of a transmission protocol is advantageous in respect of the method according to the invention because the protocol structure can be used to notify the analysis logic circuit of which reliability information about a control signal can be determined directly.

Furthermore, the signal selection apparatus is designed to receive a piece of state information and/or a piece of mission information. This can advantageously be effected using a data connection that is independent of the transmission of the control signals in order to avoid negative interactions between the control signals and the state information and/or the mission information. Alternatively, however, it is also possible to use the same data connection by using a second transmission protocol, in order to transmit state and mission information via the same data connection as is also used for conveying the control signals.

In one preferred embodiment of the invention, the computing unit of the signal selection apparatus is designed as a processor of an electronic circuit or for example in the form of a microcontroller having a processor and further peripheral modules for protocol-based communication. The computing unit is designed for signaling purposes to receive the control signals and the state information and also the mission information. Similarly, the computing unit can be of server-based design.

At least an analysis logic circuit and a formal decision logic circuit are implemented on the computing unit. The analysis logic circuit is preferably implemented in the form of a program code having one or more functions, which are each designed to evaluate the first and the second control signal for the purpose of ascertaining the first and second reliability information. The formal decision logic circuit is likewise implemented as program code and permits prioritization of the control signals for the purpose of ascertaining an overwrite signal. This is effected on the basis of the ascertained reliability information and the system state.

The system state can be ascertained using any sensor or a sensor system in the flight system that is suitable for system observation.

In one advantageous configuration, the signal selection apparatus and/or the computing unit of the signal selection apparatus is/are configured by means of an implemented probabilistic logic circuit, in particular a Bayesian filter and/or a temporal logic circuit, to ascertain at least the first or the second reliability information.

In another advantageous configuration, the signal selection apparatus has a runtime monitoring system, or is connected to a runtime monitoring system for signaling purposes, in order to capture the state information and/or the mission information of the aircraft.

The runtime monitoring system is preferably designed to perform online monitoring of an aircraft state. To this end, the runtime monitoring system can have at least one sensor and a processor-based computing module that are designed for sensor monitoring of the aircraft and the surrounding airspace. The sensor captures for example flight parameters such as e.g. the airspeed and passes said flight parameters to the computing module. Said computing module evaluates the sensor data and outputs them to the signal selection apparatus in the form of the state information.

It is within the scope of the invention for the sensors of the runtime monitoring system to be distributed over different sources. By way of example, information from sensors of the aircraft or from sensors of various ground stations can be used. Moreover, it is within the scope of the invention for a human operator to convey mission information to the runtime monitoring system e.g. after mission clearance has been given, which means that said mission information can be forwarded to the signal selection apparatus in order to ascertain a suitable control hierarchy.

In another advantageous configuration, the signal selection apparatus and/or the computing unit of the signal selection apparatus is/are connected to a database for signaling purposes in order to select the control hierarchy from a multiplicity of control hierarchies on the basis of the system state and/or the first and the second reliability information.

The database can be physically connected to the computing unit within a shared electrical circuit. Alternatively, the computing unit can be connected to a database operated on a decentralized basis for signaling purposes. A database operated on such a decentralized basis permits control hierarchies to be continually extended or adapted.

In a different advantageous configuration again, the signal selection apparatus is designed as spatially distributed and/or cascaded subsystems. Additionally or alternatively, it is connected to a subordinate or superordinate signal selection apparatus for signaling purposes in order to receive at least the first and/or the second control signal or in order to output the prioritized control signal.

In the case of wired signal transmission between the cascaded signal selection apparatuses, the number of selectable control signals can be increased without the hardware components of a signal selection apparatus needing to be adapted. In particular, the signal selection apparatuses can be of identical design and therefore easily interchangeable.

The object according to the invention is likewise achieved by an aircraft having one or more of the features described herein.

The aircraft according to the invention is preferably designed as an electrically operated aircraft and has a controller, in particular a flight control computer. The controller is designed to receive at least one control signal and to output an output signal for producing a flight state and/or a flight movement.

A crucial aspect is that the controller is connected to a signal selection apparatus according to the invention or to an advantageous development of the signal selection apparatus for signaling purposes.

The aircraft can be designed as a multicopter having a multiplicity of drive units. The controller is used to interpret incoming control signals, e.g. by means of a motor matrix, and for its part to output control signals for operating the drive units, in order to bring about a desired movement of the aircraft.

In one advantageous development, the aircraft is in the form of a vertical takeoff and landing aircraft, in particular in the form of an unmanned vertical takeoff and landing aircraft.

Vertical takeoff aircraft are particularly suitable for urban flight, since no lengthy takeoff and landing strips need to be provided, in particular in densely built-up cities.

In another advantageous development, the aircraft comprises a flight recorder that is connected to the controller and/or to the signal selection apparatus for signaling purposes. The flight recorder is designed to store at least the first and second control signals and/or the overwrite signal, the reliability information and the system state with a respective associated timestamp and/or a piece of event information.

The flight recorder comprises at least one storage unit, which is arranged in a housing such that it is not damaged in an emergency situation in the event of high accelerations, temperatures, etc., that arise.

The object according to the invention is likewise achieved by a ground station having one or more of the features described herein.

The ground station according to the invention has an inherently known control apparatus for the remote control of an aircraft. The control apparatus is designed to output an abstract and/or definite remote control input from a human pilot and/or an autopilot to a signal selection apparatus in the form of a first or a second control signal.

A crucial aspect for the ground station according to the invention is that the signal selection apparatus is designed in accordance with the signal selection apparatus according to the invention or one of the advantageous developments thereof.

The ground station is preferably designed as a takeoff and/or landing station in the form of a vertiport. Said vertiport can comprise a command center in which aircraft that are taking off and/or landing are coordinated or are controlled by means of a control apparatus. The control apparatus in this case can be e.g. designed as a virtual cockpit in which a human pilot generates definite flight guidance signals for landing the aircraft by a joystick or another suitable input means.

Additionally or alternatively, the control apparatus can comprise a mechanical autopilot that performs the takeoff and/or landing maneuvers in automated fashion.

The control signals leaving the ground station are input into a signal selection apparatus in order e.g. to give mission clearance or even to be able to take over control of the aircraft.

The object on which the invention is based is likewise achieved by a flight system having one or more of the features described herein.

The flight system comprises a manned or unmanned aircraft, having a controller, a signal selection apparatus and at least one ground station, wherein the controller of the aircraft is connected to the signal selection apparatus for signaling purposes and the ground station is connected to the signal selection apparatus for signaling purposes.

A crucial aspect for the flight system according to the invention is that the signal selection apparatus is designed in accordance with the signal selection apparatus according to the invention or one of the advantageous developments thereof.

The aircraft and the flight system likewise have the already described features and advantages of the method for signal selection according to the invention or the signal selection apparatus according to the invention and/or one of the preferred embodiments described.

### BRIEF DESCRIPTION OF THE DRAWINGS

Further preferred features and embodiments of the apparatus according to the invention and the method according to the invention are explained below on the basis of exemplary embodiments and the Figures. These exemplary embodiments are merely advantageous configurations of the invention and therefore should not be considered to be limiting.

In the Figures,

FIG. 1 shows an aircraft having a signal selection apparatus;

FIG. 2 shows a schematic depiction for the performance of a method for signal selection;

FIG. 3 shows a flight system having an aircraft and a signal selection apparatus;

FIG. 4 shows a schematic depiction of a method for signal selection that can be performed in spatially distributed fashion;

FIG. 5 shows a schematic depiction of a method for signal selection that can be performed in cascaded fashion.

### DETAILED DESCRIPTION

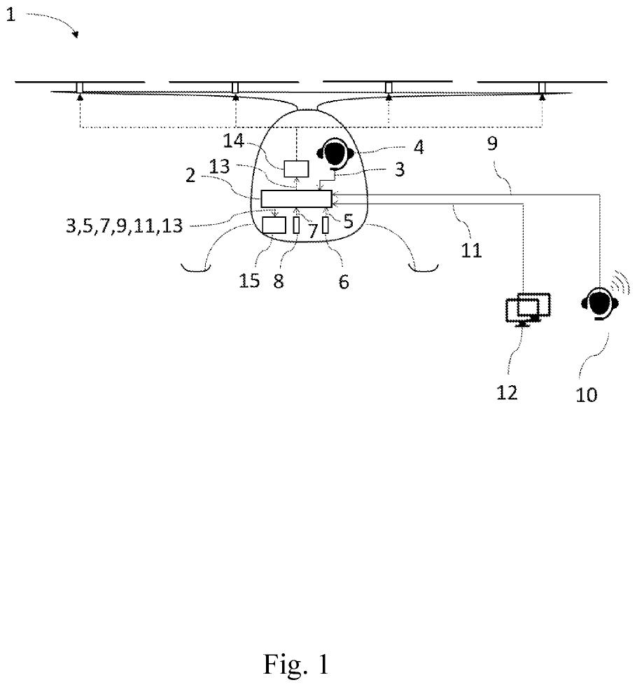

FIG. 1 shows a vertical takeoff and landing aircraft 1 having a signal selection apparatus 2.

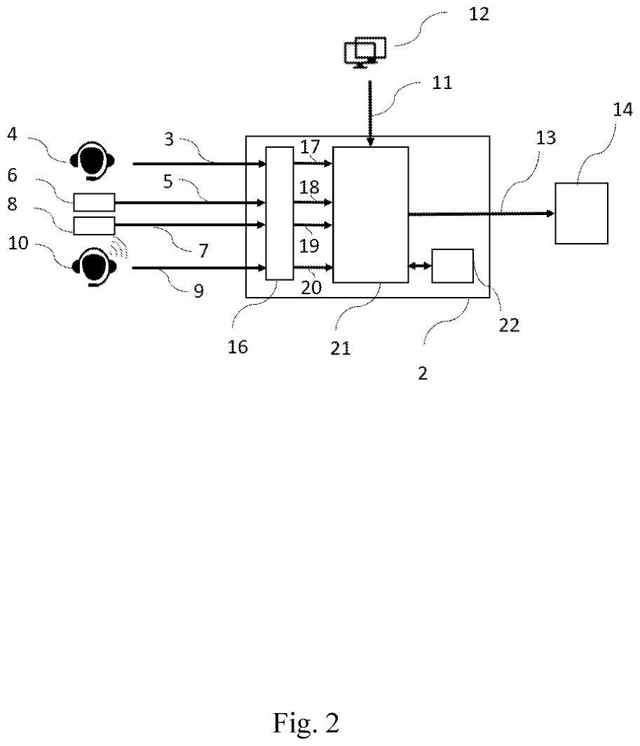

The signal selection apparatus 2 is depicted in detail in FIG. 2.

The signal selection apparatus 2 receives a first control signal 3 from a human pilot 4, a second control signal 5 from an avoidance system 6, a third control signal 7 from a landing system 8 and a fourth control signal 9 from a ground station 10. The fourth control signal 9 from the ground station 10 is transferred by means of a data link with a transmission protocol. Moreover, the signal selection apparatus 2 receives a piece of state information 11 from a runtime monitoring system 12, which is preferably installed aboard the aircraft 1 but can also be distributed over the individual functional units of the overall flight system. It can also be distributed over the functional units such that each functional unit monitors itself independently of the other functional units.

An analysis logic circuit 16 (see FIG. 2) and a decision logic circuit 21 (see FIG. 2) are used to ascertain from the control signals 3, 5, 7 and 9 a prioritized control signal 13 that is passed to a controller of the aircraft 14 in order to produce a flight movement or a flight maneuver.

The aircraft furthermore has a flight recorder 15 into which the control signals 3, 5, 7 and 9, the state information 11 and the ascertained prioritized control signal 13 are input.

FIG. 2 shows the mode of action on the basis of which the signal selection apparatus 2 ascertains the prioritized control signal 13. For the sake of better clarity, the flight recorder 15 and the signal paths leading to it are not depicted. Furthermore, only the functional blocks that are implemented on a computer or processor of the signal selection apparatus 2 in order to ascertain the prioritized control signal 13 are depicted.

The signal selection apparatus 2 has an analysis logic circuit 16 and a decision logic circuit 21.

The analysis logic circuit 16 is used to ascertain, for each of the control signals 3, 5, 7 and 9, an applicable piece of first reliability information 17 for the first control signal 3, a piece of second reliability information 18 for the second control signal 5, a piece of third reliability information 19 for the third control signal 7 and a piece of fourth reliability information 20 for the fourth control signal 9.

The pieces of reliability information each contain parameters for the variance in the respective applicable control signal. The analysis logic circuit 16 is designed as a Bayesian filter.

The analysis logic circuit inputs the reliability information 17, 18, 19 and 20 into a formal decision logic circuit 21. Similarly, the state information 11 is input into the decision logic circuit 21 by the runtime monitoring system 12. The state information 11 is used to ascertain a system state of the aircraft that permits unique identification of an operating state—for example whether the aircraft is on the “ground” or on a “mission”.

The formal decision logic circuit 21 is connected to a database 22, which is designed as part of the signal selection apparatus 2, for signaling purposes. The database 22 contains a control hierarchy.

Depending on the flight phase, each system state has an assigned unique control hierarchy that allows prioritization of the control signals.

The reliability information, the system state and the control hierarchy are therefore taken as a basis for making a unique selection for a suitable control signal 3, 5, 7 or 9, which is output to the controller 14 as prioritized control signal 13.

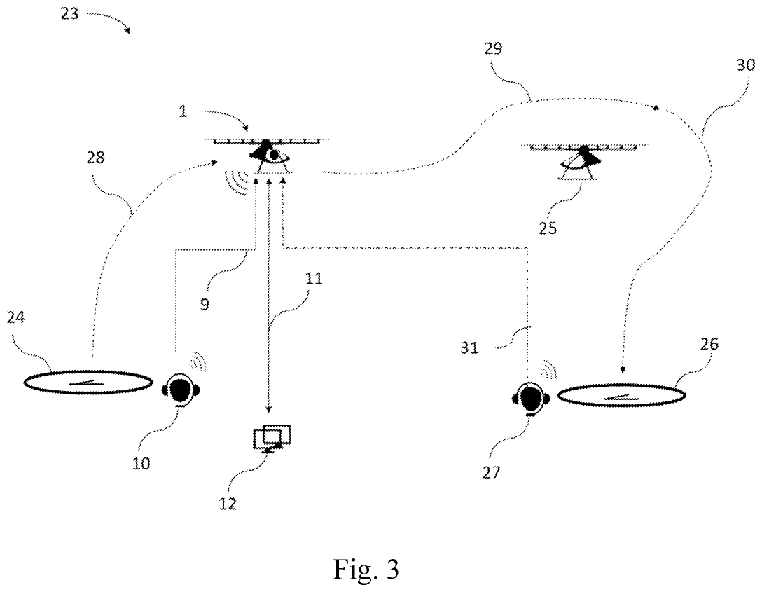

An example of the signal selection is explained with reference to FIG. 3. This Figure shows a flight system 23 having the aircraft 1 shown in FIG. 1.

The flight system 23 has a ground station 24 in the form of a takeoff vertiport, in the command center of which the fourth control signal 9 is generated and output to the aircraft as a remote control input. Furthermore, a second aircraft 25 is in the airspace of the aircraft 1. The flight system 23 has a second ground station in the form of a landing vertiport 26. The landing vertiport 26 has a human pilot 27 who generates a fifth control signal 31 in the form of a remote control input.

In principle, the aircraft 1 in the flight system 23 shown can have the operational states “ground” and “mission”, which are monitored by the runtime monitoring system 12. In the “ground” state, the aircraft 1 is in the region of the takeoff vertiport 24. The “mission” state is split into the flight phases “takeoff” 28, “avoidance” 29 and “landing” 30 by way of illustration.

In the flight system 23 shown, before flight begins, the human pilot 4 wishes to perform the “takeoff” 28 personally using the first control signal generated by them (cf. FIGS. 1 and 2). However, there is a stipulation for operation of the takeoff vertiport 24 that an aircraft cannot take off without prior mission clearance from the takeoff vertiport 24. This condition is taken into account in the database 22 for the control hierarchy that the formal decision logic circuit 21 accesses.

In this case, the formal decision logic circuit 21 first of all uses the state information 11 to ascertain which state the aircraft is in. Since the aircraft 1 is in the “ground” state prior to takeoff, the formal decision logic circuit 21 ascertains a group of possible control hierarchies in the database 22 (cf. FIG. 2) that are associated with the “ground” state. Since the fourth control signal 9 is conveyed to the signal selection apparatus 2 by means of a transmission protocol, said fourth control signal can be uniquely identified as mission clearance. As a result, the group of possible control hierarchies is limited further, which means that the first control signal 1 is ascertained as prioritized control signal 13 and is output to the controller 14 of the aircraft 1.

Following completion of the “takeoff” 28, the aircraft 1 is unexpectedly on a collision course with the second aircraft 25. Owing to this situation, the human pilot 4 reacts with a control input.

A speed sensor designed specifically for system monitoring ascertains the comparatively high airspeed and transfers it to the runtime monitoring system 12. Said runtime monitoring system recognizes from the airspeed that the aircraft 1 is in the “mission” state. On the basis of this state information from the runtime monitoring system, the formal decision logic circuit in turn ascertains a control hierarchy that is associated with the “mission” state.

At the same time, the automatic avoidance system 6 is activated on the basis of the second aircraft 25. The control hierarchy provides for the second control signal 5, which is sent to the signal selection apparatus by the avoidance system 6, to be prioritized over the other control signals. This permits an automated avoidance maneuver in accordance with the “avoidance” flight phase 29.

Following completion of the “avoidance” 29, the aircraft is on approach to land and therefore still in the “mission” state. In this case, besides the first data link that still exists to the takeoff vertiport 24, a second data link to the landing vertiport 26 is formed, which means that a fifth control signal 31 is input into the signal selection apparatus. The analysis logic circuit is used to detect that there is a timing overlap between the fourth control signal 9 from the takeoff vertiport 24 and the fifth control signal 31 from the landing vertiport. The analysis logic circuit also recognizes from the transmission protocol of the second data link that the fifth control signal 31 is a remote control input. The first data link is therefore terminated and replaced with the second data link. As a result, a so-called signal handover to the landing vertiport 26 takes place.

The fifth control signal 31 is landing clearance, which is required for the aircraft in order to be able to land at the landing vertiport 26 under normal conditions. On the basis of the “mission” state, the formal decision logic circuit of the signal selection apparatus 2 obtains a control hierarchy from the database that permits prioritization of the third control signal 7 from the landing system 8 taking account of the landing clearance. Landing is then automatically initiated.

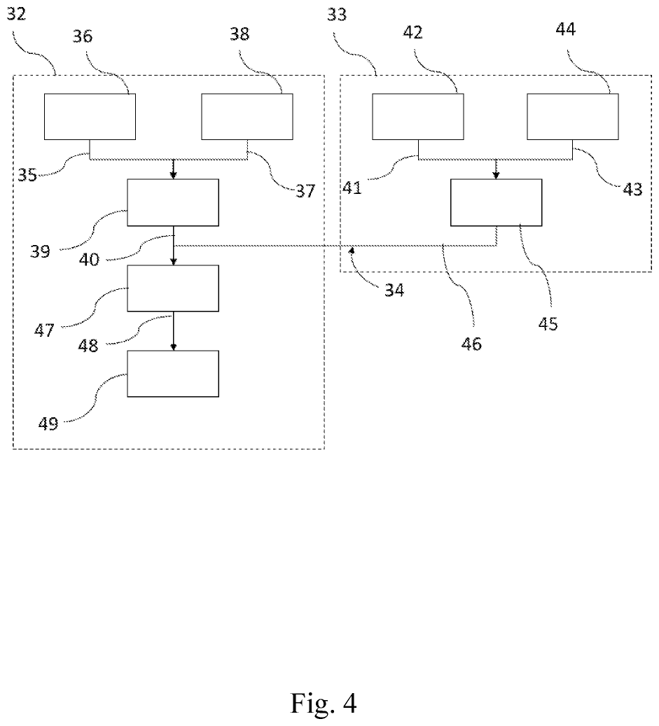

FIG. 4 shows an exemplary embodiment of the signal selection method, which takes place on the basis of spatially distributed, cascaded subsystems. In this case, one part of the signal selection is performed inside the “aircraft” subsystem 32 and another part is performed inside the “ground station” subsystem 33. The two subsystems 32/33 are connected to one another via a data link 34.

Inside the “aircraft” subsystem 32, a first control signal 35 is generated by a first human pilot 36, while a second control signal 37 is generated by a first autopilot 38. The second control signal can be dependent on a preprocessed control signal from a different pilot or a pilot apparatus (not shown). A first signal selection apparatus 39 identifies a first prioritized control signal 40, which has been explained on the basis of the described mode of action.

Inside the “ground station” subsystem 33, a third control signal 41 is generated by a second human pilot 42, while a fourth control signal 43 is generated by a second autopilot 44. A second signal selection apparatus 45 ascertains a second prioritized control signal 46 likewise on the basis of the already described mode of action within the context of FIGS. 2 and 3.

The data link 34 is used to send the second prioritized control signal 46 to the “aircraft” subsystem 32, where it is sent to a third signal selection apparatus 47 together with the first prioritized control signal 40. Said third signal selection apparatus ascertains a third prioritized control signal 48 from the two prioritized control signals 40 and 46, which third prioritized control signal is input into a controller 49.

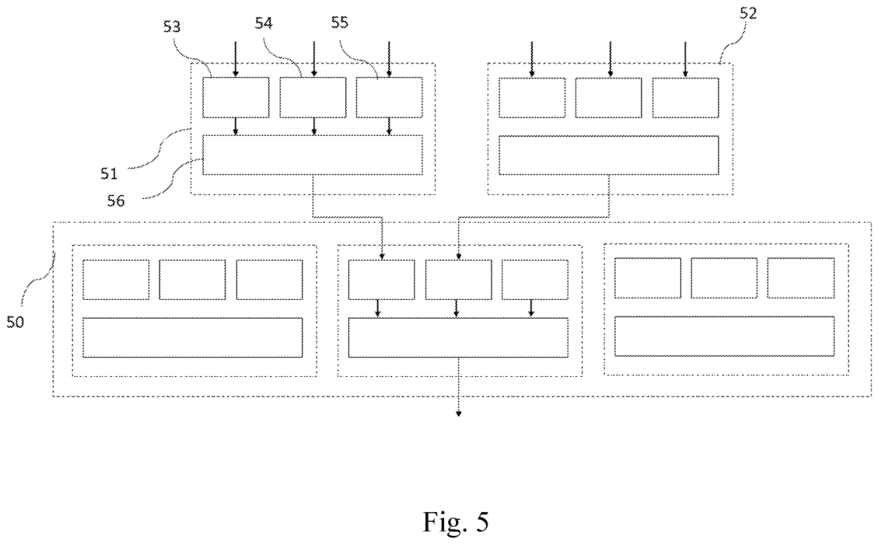

FIG. 5 shows an exemplary embodiment for the performance of the signal selection method with multiple subsystems 50, 51, 52. The subsystems 51 and 52 are identical in structure and each have three signal preprocessing modules 53, 54, 55 and in each case one signal selection apparatus 56. Each of the signal preprocessing modules 53, 54, 55 receives a sensor signal, which is processed and input into the signal selection apparatus 56 in the form of a control signal. This signal selection apparatus ascertains a prioritized control signal 13, which is subsequently transmitted to the superordinate subsystem 50 by means of a data link. The superordinate subsystem 50 in turn has subsystems that are designed in accordance with the subsystems 51 and 52.

1. A method for signal selection for a flight system (23) having an aircraft (1), and having a signal selection apparatus (2, 39, 45, 47, 56), the method comprising:
the signal selection apparatus (2, 39, 45, 47, 56) receiving at least a first control signal (3, 5, 7, 9, 35, 37, 41, 43) and a second control signal (3, 5, 7, 9, 35, 37, 41, 43), using an analysis logic circuit (16) to ascertain a piece of first reliability information (17, 18, 19, 20) for the first control signal (3, 5, 7, 9, 35, 37, 41, 43) and a piece of second reliability information (17, 18, 19, 20) for the second control signal (3, 5, 7, 9, 35, 37, 41, 43),
at least one of the first or the second control signal (3, 5, 7, 9, 35, 37, 41, 43) being dependent on a remote control input (9) from at least one of a pilot or an autopilot outside the aircraft and, in a method step A, ascertaining a system state of the aircraft (1) based on at least one of a piece of state information (11) or a piece of mission information (11) of the aircraft (1);
in a method step B, using an automated, decision logic circuit (21) to take the first and the second reliability information (17, 18, 19, 20) and the system state and a control hierarchy (22) as a basis for prioritizing the first or the second control signal (3, 5, 7, 9, 35, 37, 41, 43);
and, in a method step C, outputting the prioritized control signal (13, 40, 46, 48).

2. The method as claimed in claim 1, wherein at least one of the first or the second reliability information (17, 18, 19, 20) is ascertained in each case using probabilistic or formal methods, using at least one of Bayesian filters or temporal logic circuits.

3. The method as claimed in claim 1, wherein at least one of the state information (11) or the mission information (11) of the aircraft (1) is conveyed by a runtime monitoring system (12) in method step A.

4. The method as claimed in claim 1, wherein the control hierarchy is selected from a multiplicity of control hierarchies in a database (22) based on at least one of the system state or the first and the second reliability information (17, 18, 19, 20).

5. The method as claimed in claim 1, wherein the method for signal selection is carried out as a spatially distributed selection method, with at least one of decentralized control preselection or decentralized signal processing based on spatially distributed subsystems (50, 51, 52).

6. The method as claimed in claim 1, wherein the method for signal selection is carried out as a cascaded method, wherein the signal selection apparatus (2, 39, 45, 47) at least one of receives at least the first or the second control signal (3, 5, 7, 9, 35, 37, 41, 43) from a subordinate signal selection apparatus (39, 45) or outputs the prioritized control signal (13, 40, 46, 48) to a superordinate signal selection apparatus (47, 56).

7. The method as claimed in claim 1, further comprising, in a method step D, the aircraft receiving the prioritized control signal (13, 40, 46, 48) and using the prioritized control signal (13, 40, 46, 48) as a basis for autonomously changing over between at least a first and a second operating state (28, 29, 30).

8. The method as claimed in claim 1, further comprising the signal selection apparatus sending at least the received first control signal (3, 5, 7, 9, 35, 37, 41, 43) and the received second control signal (3, 5, 7, 9, 35, 37, 41, 43), the ascertained reliability information (17, 18), the system state and the prioritized control signal (13, 40, 46) with at least one of a respective associated timestamp or a piece of event information to a flight recorder (15) in the method step C.

9. A signal selection apparatus for a flight system (23) including an aircraft (1), the signal selection apparatus (2, 39, 45, 47) comprising:
a processor configured to:
(a) receive a first control signal (3, 5, 7, 9, 35, 37, 41, 43) and a second control signal (3, 5, 7, 9, 35, 37, 41, 43), and including an implemented analysis logic circuit (16) configured to ascertain a piece of first reliability information (17, 18, 19, 20) for the first control signal (3, 5, 7, 9, 35, 37, 41, 43) and to ascertain a piece of second reliability information (17, 18, 19, 20) for the second control signal (3, 5, 7, 9, 35, 37, 41, 43),
(b) receive at least the first or the second control signal (3, 5, 7, 9, 35, 37, 41, 43) from a remote control input (9) from at least one of a pilot or an autopilot,
(c) ascertain a system state of the aircraft (1) based on at least one of a piece of state information (11) or a piece of mission information (11) of the aircraft (1), and
an implemented decision logic circuit (21), executable in automated fashion, configured to prioritize the first or the second control signal (3, 5, 7, 9, 35, 37, 41, 43) based on the first and the second reliability information (17, 18, 19, 20) and the system state and a control hierarchy, and
the processor being further configured to output the prioritized control signal (13, 40, 46) by a protocol-based data link (34).

10. The signal selection apparatus (2, 39, 45, 47, 56) as claimed in claim 9, wherein the analysis logic circuit (16) is a probabilistic logic circuit, including at least one of a Bayesian filter or a temporal logic circuit, and is configured to ascertain at least the first or the second reliability information (17, 18, 19, 20).

11. The signal selection apparatus (2, 39, 45, 47, 56) as claimed in claim 9, further comprising a runtime monitoring system (12) configured to monitor signals in order to capture at least one of a piece of state information (11) or a piece of mission information of the aircraft.

12. The signal selection apparatus (2, 39, 45, 47, 56) as claimed in claim 9, wherein the signal selection apparatus (2, 39, 45, 47, 56) is connected to a database (22) in order to select the control hierarchy from a multiplicity of control hierarchies based on at least one of the system state or the first and the second reliability information (17, 18, 19, 20).

13. The signal selection apparatus (2, 39, 45, 47, 56) as claimed in claim 9, wherein the signal selection apparatus (2, 39, 45, 47, 56) at least one of comprises at least one of spatially distributed or cascaded subsystems (50, 51, 52), is connected to a subordinate signal selection apparatus (51, 52) for signaling purposes in order to receive at least the first or the second control signal (3, 5, 7, 9, 35, 37, 41, 43), or is connected to a superordinate signal selection apparatus (47, 50) for signaling purposes in order to output the prioritized control signal (13, 40, 46).

14. An aircraft (1), comprising:
a controller (14) configured to receive at least one external control signal (13, 40, 46, 48), and
a signal selection apparatus as claimed in claim 9.

15. The aircraft as claimed in claim 14, wherein the aircraft (1) is a vertical takeoff and landing aircraft.

16. The aircraft as claimed in claim 14, further comprising a flight recorder (15) that is connected to at least one of the controller (14) or to the signal selection apparatus (2, 39, 45, 47, 56) for signaling purposes and the flight recorder (14) is configured to store at least one of the first and second control signals (3, 5, 7, 9, 35, 37, 41, 43) or the prioritized control signal (13, 40, 46, 48), the reliability information (17, 18, 19, 20) and the system state with at least one of a respective associated timestamp or a piece of event information.

17. A ground station (10, 24, 26) comprising;
a control apparatus for remote control of an aircraft (1), wherein the control apparatus is configured to output a remote control input (9) from at least one of a human pilot or an autopilot to a signal selection apparatus (2, 39, 45, 47, 56) in the form of a first or a second control signal (3, 5, 7, 9, 35, 37, 41, 43), and
the signal selection apparatus (2, 39, 45, 47, 56) as claimed in claim 9.

18. A flight system, comprising a manned or unmanned aircraft (1), having a controller (14), the signal selection apparatus (2, 39, 45, 47, 56) as claimed in claim 9, and at least one ground station (10, 24, 26), wherein the controller (14) of the aircraft (1) is connected to at least the signal selection apparatus (2, 39, 45, 47, 56) for signaling purposes and the ground station (10, 24, 26) is connected to at least the signal selection apparatus (2, 39, 45, 47, 50) for signaling purposes.
